(19) United States
(12) Patent Application Publication
(10) Pub. No.: US 2013/0012104 A1
(43) Pub. Date: Jan. 10, 2013

(54) MANUFACTURING METHOD OF A GLASS SUBSTRATE FOR A MAGNETIC DISK

(75) Inventors: Tomoyuki Yamaguchi, Tokyo (JP); Yasunari Hirano, Tokyo (JP); Takuhiro Hirakawa, Tokyo (JP)

(73) Assignee: HOYA CORPORATION, Shinjuku-ku, Tokyo (JP)

(21) Appl. No.: 13/379,853

(22) PCT Filed: Mar. 31, 2011
(86) PCT No.: PCT/JP2011/058324

§ 371 Date: Apr. 27, 2012

(30) Foreign Application Priority Data
Mar. 31, 2010 (JP) 2010-081806

(51) Int. Cl. G11B 5/84; B24B 7/24; C03C 23/00

(52) U.S. Cl. 451/41; 134/3

(57) ABSTRACT

The present invention has an object to remove effectively metallic contaminants adhering to the glass substrate surfaces without increasing roughness of the glass substrate surfaces in the glass substrate for a magnetic disk. In a manufacturing method of a glass substrate for a magnetic disk having a cleaning step of the glass substrate, cleaning step having a treatment of contacting the glass substrate with a cleaning liquid containing oxalate and divalent iron ions and having a pH of not less than 2 and not more than 4. The divalent iron ions are added by adding ammonium iron (II) sulfate, iron (II) sulfate and iron oxalate (II) to oxalic acid.

### TECHNICAL FIELD

The present invention relates to a manufacturing method of a glass substrate for a magnetic disk.

### BACKGROUND ART

With advancement of information technology, information recording technology, particularly magnetic recording technology, has progressed remarkably. In a magnetic disk used for an HDD (hard disk drive) which is one of the magnetic recording media and so on, rapid miniaturization, production of thinner disk, increase in recording density and speedup of access rate have been continued. The HDD performs recording and playbacking while allowing a magnetic disk having a magnetic layer on a discal substrate to rotate at a high rate and allowing a magnetic head to fly floating above this magnetic disk.

Higher substrate strength is demanded for a magnetic disk since the rotary rate of the magnetic disk increases with the increase of access rate. In addition, with the increase of recording density, the magnetic head changes from a thin film head to a magnetoresistive head (MR head), further to a giant magnetoresistive head (GMR head), and the flying height from the magnetic disk of the magnetic head becomes narrower to around 5 nm. On this account, when there are irregularities on the magnetic disk surfaces, there may be caused crash failure due to collision of the magnetic head, thermal asperity failure which leads to read errors due to heat caused by adiabatic compression of the air or contact thereof. It becomes important to finish the main surfaces of the magnetic disk as an extremely smooth surface to suppress such troubles caused on the magnetic head.

Therefore, glass substrates have come to be used lately as substrates for a magnetic disk in place of conventional aluminum substrates. This is because the glass substrates consisting of glass, which is a rigid material, can be superior to the aluminum substrates consisting of a metal, which is a flexible material, in smoothness of the substrate surfaces, substrate strength and rigidness. The glass substrates used for these magnetic disks are produced by subjecting the main surfaces to grinding and polishing, etc. The grinding and polishing of the glass substrates can be performed by a method using a double-sided polishing apparatus having planet gear mechanism. In the planet gear mechanism, a glass substrate is sandwiched with upper and lower surface plates having abrasive pads (abrasive cloth) affixed thereto, and while an abrasion liquid in which abrasive grains (slurry) are mixed and suspended is supplied between the abrasive pads and the glass substrate, the glass substrate is moved relatively to the upper and lower surface plates thereby finishing the main surfaces of the glass substrate as surfaces having predetermined smoothness (for example, see Patent Document 1).

In addition, thin films (magnetic layers) of a several-nm level are formed on the glass substrate for a magnetic disk the surfaces of which have been smoothed by grinding and polishing, etc., thereby forming recording and playbacking trucks and so on. Therefore, in the manufacturing method of a glass substrate for a magnetic disk, it is an important assignment to remove even slight contamination on the glass substrate surfaces to keep clean the substrate surfaces as well as to achieve smoothing by grinding and polishing.

The glass substrate has also an aspect of a brittle material. Therefore, in the manufacturing method of a glass substrate for a magnetic disk, the glass substrate is dipped in a heated chemical strength liquid and lithium and sodium ions of the glass substrate surfaces layers are ion-exchanged respectively with sodium and potassium ions in the chemical strength liquid thereby forming compressive stress layers on the surface layers of the glass substrate so that they may be strengthened (glass strength step).

In addition, it is known that cleaning under acidic condition is finally performed to make clean the substrate surfaces after the above-mentioned step.

### CITATION LIST

### Patent Literature

[Patent Literature 1] Japanese Patent Laid-Open No. 2009-214219

### SUMMARY OF INVENTION

### Technical Problem

In the meantime, in the production apparatus used for production steps of a glass substrate for a magnetic disk, there is a case wherein member(s) made of stainless steel is used for a grinding apparatus, a polishing apparatus as shown in Patent Document 1. In addition, there is a case wherein materials made of stainless steel are also used in the chemical strength step. In other words, metallic contaminant (particularly iron-based contaminant) caused by stainless steel from these apparatuses might occur and adhere to the glass substrate when production steps with apparatuses made of stainless steel are performed. Besides, there is a case wherein metallic contaminant is included in sub-materials used in respective steps such as abrasive grains used in the grinding apparatus and polishing apparatus.

Contamination which would have an influence on the glass substrate, particularly contamination caused by sticking of fine metallic particles should be removed in the production steps of the glass substrate for magnetic recording disks since it will produce irregularities on the surfaces after the film formation of the magnetic layer, which then cause reduction of electrical characteristics such as recording and playback characteristic and yield of the product. Consideration on contaminants caused by the materials of the apparatuses becomes necessary when it is taken into consideration that the flying height from the magnetic disks of the magnetic head decreases more and more with the improvement of the recording density.

However, it is necessary to use acidic solutions having strong reactivity (for example, aqua regia) in order to remove these metallic contaminants since the metallic contaminants derived from stainless steels are hard to be corroded, and it is difficult to remove them with cleaning liquids such as acidic aqueous solutions or alkaline aqueous solutions which are generally used by cleaning step.

On the other hand, when an acidic solution having strong reactivity is used as a cleaning liquid, the surface of the glass substrate is affected, which causes a problem that surface roughness increases. Accordingly, cleaning treatment using a cleaning liquid which can remove effectively the metallic contaminants strongly sticking onto the glass substrate and does not affect the glass substrate is demanded so as to improve smoothness and cleanness of the glass substrate surfaces still more.

In late years an HDD equipped with a DFH (Dynamic Flying Height) technique in the head has been developed to improve recording density still more. This technology enables to bring the head element part closer to the media surfaces than before so that magnetic spacing may be reduced, but in the meantime, it has been revealed that it is necessary to make smoother and cleaner the main surfaces of the magnetic disks having less defects such as contaminating substances more than before when the DFH head is used. It is supposed that this is caused by the fact that the head element part is affected even by disorder with a little surface irregularities or even by contact with contaminating substances since the DFH head mechanism does not decrease the flying height of the main body of the head so that the main body can approach the magnetic disk surface but pushes out only the region around the head element part so that the latter can approach the media surface. For example, in order to achieve recording density of more than 500 GB per one piece of 2.5-inch magnetic disk, it is demanded to make the gap between the pushed-out head element part and the magnetic disk preferably not more than 1 nm.

The present invention has been accomplished in consideration of the above-mentioned problem, and an object thereof is to remove effectively metallic contaminants adhering to the glass substrate surfaces, without increasing roughness of the glass substrate surfaces in the glass substrate for a magnetic disk.

### Means for Solving the Problems

The manufacturing method of a glass substrate for a magnetic disk of the present invention is characterized in that the process comprises a cleaning step and the cleaning step comprises a treatment of contacting the glass substrate with a cleaning liquid containing oxalic acid and divalent iron ions and having a pH of not less than 2 and not more than 4.

In the manufacturing method of a glass substrate for a magnetic disk of the present invention, it is preferable that the concentration of the oxalic acid in the cleaning liquid is not less than 0.2 wt % and not more than 3.0 wt %.

In the manufacturing method of a glass substrate for a magnetic disk of the present invention, it is preferable that the cleaning liquid is prepared by adding a material which can supply divalent iron ions.

In the manufacturing method of a glass substrate for a magnetic disk of the present invention, it is preferable that the material which can supply divalent iron ions is at least one kind selected from a group consisting of ammonium iron (II) sulfate, iron (II) sulfate and iron (II) oxalate.

In the manufacturing method of a glass substrate for a magnetic disk of the present invention, it is preferable that the concentration of ammonium iron (II) sulfate, iron (II) sulfate or iron (II) oxalate in the cleaning liquid is not less than 0.015 wt % and not more than 0.3 wt %.

In the manufacturing method of a glass substrate for a magnetic disk of the present invention, it is preferable that the cleaning liquid further comprises ascorbic acid or a thioglycolic acid-based compound.

In the manufacturing method of a glass substrate for a magnetic disk of the present invention, it is preferable that the concentration of ascorbic acid or a thioglycolic acid-based compound in the cleaning liquid is not less than 0.2 wt % and not more than 0.5 wt %.

In the manufacturing method of a glass substrate for a magnetic disk of the present invention, it is preferable that the cleaning liquid further comprises an alkaline aqueous solution.

In the manufacturing method of a glass substrate for a magnetic disk of the present invention, it is preferable to remove iron oxides) on the glass substrate by contacting the cleaning liquid and the glass substrate.

### Technical Advantage of the Invention

According to one embodiment of the present invention, the metallic contaminants adhering to the glass substrate surfaces can be removed effectively without increasing roughness of the glass substrate surfaces.

### BRIEF DESCRIPTION OF DRAWINGS

FIG. 1 is a drawing which shows an example of reaction formula for the case wherein a cleaning treatment of the glass substrate is performed with a cleaning liquid consisting of oxalic acid.

FIG. 2 is a drawing which shows an example of reaction formula for the case wherein a cleaning treatment of the glass substrate is performed with a cleaning liquid having divalent iron ions supplied to oxalic acid.

### DESCRIPTION OF EMBODIMENTS

In the following, embodiments of the present invention are described with drawings, working examples and so on. These drawings, working examples and descriptions exemplify the present invention and they do not limit the scope of the present invention. It goes without saying that the any other embodiments can belong to the scope of the present invention as far as they are compatible to the objects of the present invention.

The present inventors conducted studies in order to achieve further smoothness and improvement of cleanness of the glass substrate and they faced a problem that metallic contaminants (for example, iron-based contaminants) caused by materials in production apparatuses of a glass substrate for a magnetic disk and sub-materials used in respective steps adhered to the glass substrate and they could not be sufficiently removed with an ordinary cleaning treatment. Under the circumstances, as a result of intensive studies for a process for removing metallic contaminants from stainless steel without increasing surface roughness of the glass substrate, the present inventors found a process which could effectively remove metallic contaminants (particularly, iron-based contaminants) without affecting the surfaces of the glass substrate by using a cleaning liquid having divalent iron ions added to oxalic acid. In the following, specific examples of the manufacturing method of a glass substrate for a magnetic disk of the present invention are described.

The manufacturing method of a glass substrate for a magnetic disk of the present embodiment is characterized in that the process comprises a cleaning step and the cleaning step comprises a treatment of contacting the glass substrate with a cleaning liquid containing oxalic acid and divalent iron ions and having a pH of not less than 1.8 and not more than 4.2, preferably a pH of not less than 2 and not more than 4. The cleaning liquid can be prepared by adding a solution which can supply divalent iron ions to an oxalic acid aqueous solution.

Either one of ammonium iron (II) sulfate, iron (II) sulfate and iron oxalate (II) can be used for the solution which can supply divalent iron ions.

In addition, it is preferable to further add a reducing agent (antioxidant) such as ascorbic acid or a thioglycolic acid-based compound to the oxalic acid aqueous solution which functions as a cleaning liquid. The ascorbic acid or thioglycollic acid-based compound functions as an antioxidant (reducing agent) of the iron ion in the cleaning liquid. As for the reducing agent, thioglycolic acid, ammonium thioglycolate, thioglycolic acid monoethanolamine, etc. can be used as a thioglycolic acid-based compound which reduces a trivalent iron ion occurring in the cleaning liquid to divalent iron ions.

When divalent iron ions is supplied to an oxalic acid aqueous solution, a complex of the divalent iron ion adsorbs onto particle surfaces of iron oxide of oxidation number 3, and reductive reaction occurs to promote the dissolution reaction of the iron (III) oxide. In other words, it is enabled to effectively remove iron oxide (particularly, iron (III) oxide) adhering to the surface of the glass substrate by adding a solution which supplies a divalent iron ions such as ammonium iron (II) sulfate to oxalic acid.

In addition, pH of the cleaning liquid is adjusted to not less than 1.8 and not more than 4.2, preferably not less than 2 and not more than 4. When pH is less than 1.8, there is a case wherein roughness of the glass substrate becomes too large and when pH exceeds 4.2, contaminating substances on the glass substrate cannot be removed effectively. The regulation of the pH can be performed with an acid such as the sulfuric acid and an alkali such as potassium hydroxide (KOH) or sodium hydroxide (NaOH).

In the cleaning liquid, it is preferable that the oxalic acid concentration is not less than 0.005 mol/L and not more than 0.3 mol/L (preferably not less than 0.2 wt % and not more than 3.0 wt %). This is because that when the oxalic acid concentration is less than 0.2 wt %, the removal effect of the iron oxide particles is insufficient and the effect does not change even when the concentration exceeds 3.0 wt %. Needless to say, the concentration may surpass 3.0 wt %. Here, the oxalic acid concentration as used herein refers to the value including the dissociated oxalate ion.

In the case wherein ammonium iron (II) sulfate is added to oxalic acid as the cleaning liquid, it is preferable that the concentration of ammonium iron (II) sulfate is not less than 0.0001 mol/L and not more than 0.005 mol/L (preferably not less than 0.015 wt % and not more than 0.3 wt %). This is because that when the concentration of ammonium iron (II) sulfate is less than 0.015 wt %, contaminating substances on the glass substrate cannot be removed effectively and further effect cannot be obtained even when the concentration exceeds 0.3 wt %. Needless to say, the concentration may surpass 0.3 wt %.

In addition, when ascorbic acid or a thioglycollic acid-based compound is added to the cleaning liquid, it is preferable that the concentration of the reducing agent such as ascorbic acid or a thioglycolic acid-based compound is not less than 0.001 mol/L and not more than 0.06 mol/L (preferably not less than 0.2 wt % and not more than 0.5 wt %. This is because that when the concentration is less than 0.2 wt %, the above-mentioned sufficient effects as an antioxidant (reducing agent) cannot be obtained and the cleaning cannot be performed stably, and the effect does not change even when the concentration exceeds 0.5 wt %. Needless to say, the concentration may surpass 0.5 wt %.

Besides, the higher the temperature of the cleaning liquid is, the larger the dissolution effect becomes, but when the temperature elevates excessively, there are caused problems that the surface roughness of the glass substrate increases and the substrate dries during transportation. Therefore, it is preferable that the temperature of the cleaning liquid is not lower than room temperature and not higher than 60° C.

In the following, mechanism of removing the iron-based contaminants adhering to the glass substrate, with a cleaning liquid in which divalent iron ions has been added to an oxalic acid aqueous solution is described.

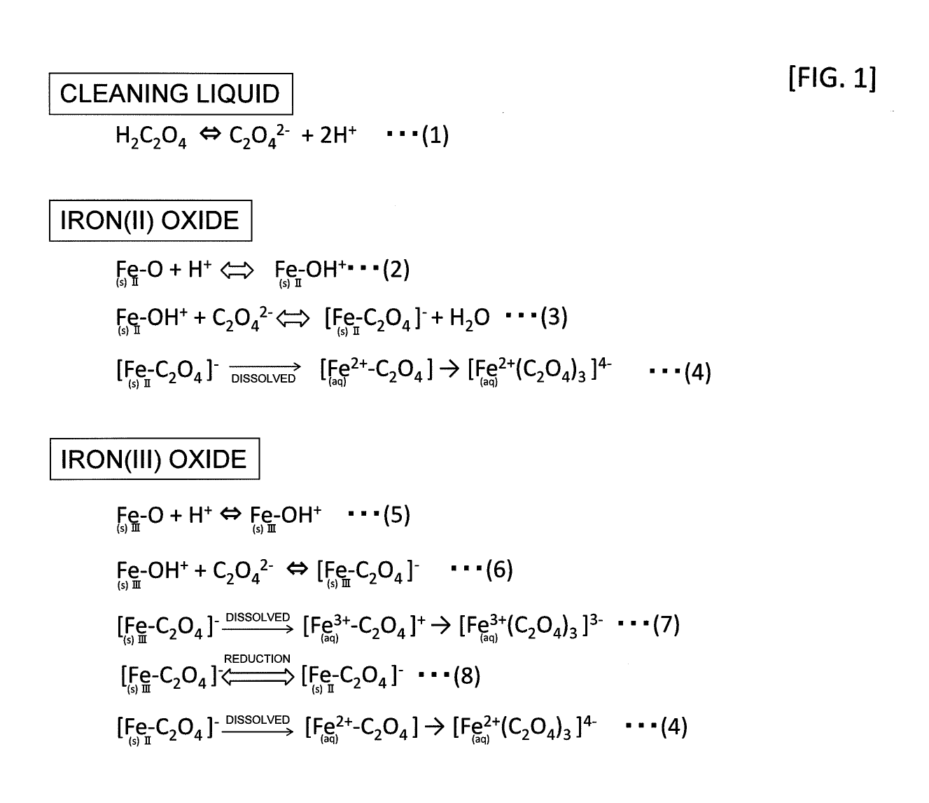

At first, the case wherein oxalic acid to which divalent iron ions is not added is used as a cleaning liquid is described referring to FIG. 1. As for the iron-based contaminants sticking to the glass substrate, removal of the iron oxide of oxidation number 2 and the iron oxide of oxidation number 3 are considered since the iron-based contaminants are generally the iron oxide of oxidation number 2 and the iron oxide of oxidation number 3.

When oxalic acid is applied as a cleaning liquid, the reaction of the divalent iron oxide (oxidation number 2) is as shown in (2) to (4) in FIG. 1. The reactions of (3) and (4) proceed relatively promptly even in an oxalate solution, the iron oxide contamination of oxidation number 2 can be removed by using an oxalic acid aqueous solution.

When oxalic acid is applied as a cleaning liquid, the reaction of the iron oxide of oxidation number 3 is as shown in (5) to (8) and (4) in FIG. 1. Here, the reactions of (7) and (8) proceed slowly in an oxalate solution and high temperature/strong acidic condition is necessary to improve the reaction rate, which increases the surface roughness. Accordingly, it becomes difficult to remove particles of the iron oxide of oxidation number 3 without increasing surface roughness of the glass substrate in an oxalate solution. In addition, since most of the iron oxide particles generally exist in oxidation number 3, cleaning becomes insufficient only with an oxalate solution.

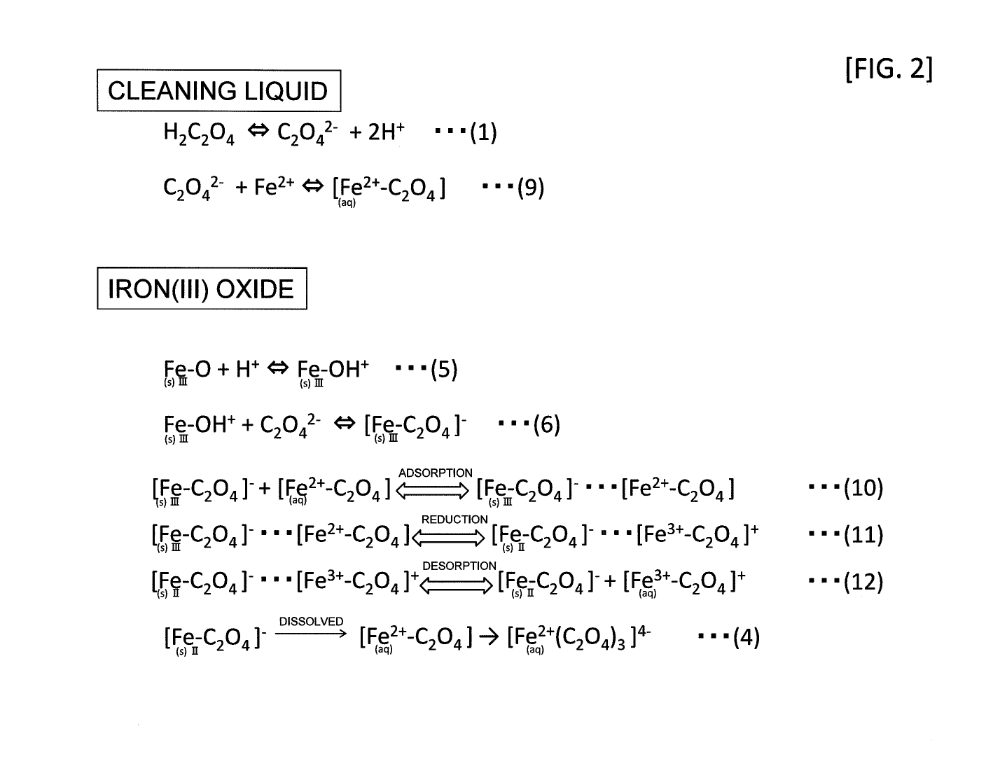

Next, the case wherein oxalic acid to which divalent iron ions is added is used as a cleaning liquid is described referring to FIG. 2.

When divalent iron ions is added to oxalic acid, a complex is formed. Then the divalent complex of the iron ions adsorbs onto the surface of the iron oxide of oxidation number 3 effectively to cause reductive reaction so that the dissolution reaction of the iron (III) oxide can proceed effectively ((10) to (12), (4) of FIG. 2). The reactions of (10) to (12) of FIG. 2 occur since divalent iron ions is supplied to an oxalate solution. Describing in detail, solid Fe (II) in the formula (12) disappears by the reaction (4), reactions of three chemical formulas (10) to (12) are promoted to the right direction in sequence so as to maintain the equilibrium. On this account, solid Fe (III) of the starting point dissolves and disappears. As described above, the dissolution reaction of the iron oxide of oxidation number 3 can be made to effectively proceed by supplying divalent iron ions to an oxalate solution.

Therefore, iron oxide based particles (iron oxide of oxidation number 3 in particular) adhering to the glass substrate can be removed effectively by using an oxalate solution in which divalent iron ions is added to an oxalic acid as a cleaning liquid.

As described above, it is preferable that the pH of the cleaning liquid is adjusted so that it may be not less than 1.8 and not more than 4.2, preferably not less than 2 and not more than 4. This is because when pH is less than 1.8, the reaction in which oxalic acid dissociates to an oxalate ion and a proton becomes slow, and the complex forming rate with divalent iron ions and the oxalate ion decreases. This is also because the reactions of above (2) and (6) are inhibited when pH is more than 4.2.

After the cleaning step mentioned above, another cleaning step with an alkaline aqueous solution may be further performed. Since the cleaning step mentioned above is an acidic cleaning, there is a case wherein a heterogeneous layer (altered layer) on the glass substrate surfaces is generated (particularly when a strong acidic condition is employed). In this case, the heterogeneous layer can be removed by carrying out an alkaline cleaning. Besides, remaining oxalate ion on the glass substrate surfaces can be completely removed by the cleaning with an alkaline aqueous solution, and therefore, corrosion by acid remaining on the glass substrate surfaces after cleaning can be completely prevented. Here in the alkali cleaning, ultrasonication may be applied.

In the following, respective steps of the manufacturing method of the substrate for a magnetic disk are described. It should be noted that the order of the respective steps may be appropriately exchanged.

### (1) Material Processing Step and First Lapping Step

At first, sheet glass can be used in the material processing step. This sheet glass can be produced by well-known manufacturing methods including, for example, press method, float method, down draw method, redraw method and fusion method using molten glass as a material. If the press method is used among these methods, sheet glass can be produced at a low cost.

In the first lapping step, both the main surfaces of the disk-shaped glass are subjected to lapping to mainly adjust flatness and board thickness of the glass substrate. The lapping can be carried out using a double-sided lapping machine employing a planetary gear mechanism with the use of alumina-based free abrasive grains. Specifically, the lapping is carried out by pressing lapping surface plates onto the both surfaces of the disk-shaped glass from the upper and lower sides, supplying a grinding fluid containing the free abrasive grains onto the main surfaces of the disk-shaped glass, and relatively moving them to each other. Iron-based materials may be used for the lapping surface plates. By this lapping, the glass substrate having flat main surfaces can be obtained.

### (2) Cutting-Out Step (Coring Step for Forming Opening, Chamfering Step (Chamfered Surface Forming Step) to Form Chamfered Surfaces at Peripheral Edge Regions (Outer Peripheral Edge Region and Inner Peripheral Edge Region))

In the coring step, an inner opening is formed at the center part of this glass substrate, for example, with a cylindrical diamond drill, thereby obtaining an annular glass substrate. In the chamfering step, grinding is applied to the outer peripheral edge face and inner peripheral edge face using diamond grindstones, thereby carrying out predetermined chamfering processing.

### (3) Second Lapping Step

In the second lapping step, the second lapping is applied to both the main surfaces of the obtained glass substrate in the same manner as in the first lapping step. By performing this second lapping step, fine irregularities formed on the main surfaces, for example, in the cutting-out step as a previous step can be removed in advance. Consequently, it becomes possible to complete a subsequent main surface polishing step in a short time.

### (4) Edge Face Polishing Step

In the edge face polishing step, the outer peripheral edge face and inner peripheral edge face of the glass substrate are mirror-polished by a brush polishing method. For this purpose, as polishing abrasive grains, a slurry (free abrasive grains) containing cerium oxide abrasive grains can be used. By this edge face polishing step, segregation of sodium and potassium can be prevented and the edge faces of the glass substrates are finished to a mirror surface state which can prevent the generation of particles, cause of thermal asperity and so on, and the adhesion thereof to the edge face regions.

### (5) Main Surface Polishing Step (First Polishing Step)

The first polishing step is first carried out as a main surface polishing step. This first polishing step mainly aims to remove cracks or strains remaining on the main surfaces during the foregoing lapping step. In this first polishing step, the main surfaces are polished with a double-sided polishing machine having a planetary gear mechanism along with the use of a hard resin polisher. Cerium oxide abrasive grains may be used as a polishing agent. The glass substrate subjected to the first polishing step can be washed with a neutral detergent, pure water, IPA, etc.

### (6) Chemical Strength Step

Chemical strength was applied to the glass substrate subjected to the foregoing lapping and polishing steps in the chemical strength step. As a chemical strength liquid used for chemical strength, for example, a mixed solution of potassium nitrate (60%) and sodium nitrate (40%) can be used. The chemical strength is performed by heating the chemical strength liquid to 300° C. to 400° C. and preheating the glass substrate for which cleaning is finished to 200° C. to 300° C. and dipping the substrate in the chemical strength solution for three hours to four hours. It is preferable that this dipping is performed in a state that plural glass substrates are held at the edge faces in a holder so that the whole of the both surfaces of the glass substrates are chemically strengthened.

Lithium and sodium ions in the surface layer of the glass substrates are respectively substituted with sodium and potassium ions having relatively larger radii in the chemical strength solution by performing a dipping treatment in the chemical strength solution in this way, thereby the glass substrates are strengthened. The chemically strengthened glass substrates are washed with pure water or the like after washed with sulfuric acid.

### (7) Main Surface Polishing Step (Final Polishing Step)

Next, the second polishing step is carried out as a final polishing step. This second polishing step is a step aiming to finish both the main surfaces to mirror-like surfaces. In this second polishing step, both the main surfaces are mirror-polished with a double-sided polishing machine having a planetary gear mechanism along with the use of a soft foaming resin polisher. Cerium oxide abrasive grains, colloidal silica or the like which are finer than the cerium oxide abrasive grains used in the first polishing step may be used as a slurry.

### (8) Cleaning Step

The glass substrate is subjected to cleaning step after the chemical strength step. The cleaning step is a step aiming to remove particles adhering to the surface of the glass substrate after the chemical strength step.

For the cleaning step, a cleaning step comprising a treatment of contacting the glass substrate with a cleaning liquid containing oxalic acid and divalent iron ions and having a pH of not less than 1.8 and not more than 4.2, preferably a pH of not less than 2 and not more than 4. Specifically, a material which supplies divalent iron ions is added to oxalic acid as a cleaning liquid. Examples thereof include ammonium iron (II) sulfate, iron (II) sulfate, iron oxalate (II). Furthermore, reducing agents (antioxidants) such as ascorbic acid or thioglycollic acid-based compounds can be added. For example, when the cleaning liquid is prepared by adding ammonium iron (II) sulfate and ascorbic acid to oxalic acid, the concentration of oxalic acid may be adjusted to not less than 0.2 wt % and not more than 3.0 wt %, the concentration of ammonium iron (II) sulfate to not less than 0.015 wt % and not more than 0.3 wt %, and the concentration of ascorbic acid to not less than 0.2 wt % and not more than 0.5 wt %.

This cleaning treatment enables to remove iron-based contaminants derived from apparatuses and materials (stainless steel) of the sub-materials adhering to the glass substrate surfaces without increasing surface roughness of the glass substrate. Besides, iron-based contaminants can be removed effectively by performing the above-mentioned cleaning step even if iron-based contaminants adhering before the chemical strength step and during the chemical strength step by the chemical strength step, adhere to the glass substrate so strongly that they are not able to remove even by physical removing methods such as scrub cleaning. In particular, the above-mentioned cleaning treatment becomes effective when the apparatus to use for the chemical strength step contains materials made of stainless steel. The cleaning step may be performed in combination with the other cleaning treatments in addition to the above-mentioned treatment. For example, combination with alkali cleaning can impart removing effect for the other contaminants and improve general cleaning power.

Heretofore is shown a constitution to perform a cleaning step using a cleaning liquid in which a divalent iron ions is added to oxalic acid after chemical strength, but it may be performed before the chemical strength step or both before and after the chemical strength step. For example, cleaning using the cleaning liquid mentioned above can be performed after the first lapping step and/or the second lapping step.

### <Step for Producing Magnetic Disks (Recording Layer and the Like Forming Step)>

Perpendicular magnetic recording disks can be produced by film-forming, for example, an adhesion layer, a soft magnetic layer, a nonmagnetic underlayer, a perpendicular magnetic recording layer, a protective layer and a lubricating layer sequentially on the main surfaces of the glass substrate obtained through the foregoing steps. Cr alloys and so on can be mentioned as materials constituting the adhesion layer. CoTaZr group alloys and so on can be mentioned as materials constituting the soft magnetic layer. A granular nonmagnetic layer and so on can be mentioned as the nonmagnetic underlayer. A CoPt granular magnetic layer and so on can be mentioned as the perpendicular magnetic recording layer. Hydrogenated carbons and so on can be mentioned as materials constituting a protective layer. Fluorine resins and so on can be mentioned as materials constituting the lubrication layer. For example, these recording layers and the like can be formed more specifically by film-forming an adhesion layer of CrTi, a soft magnetic layer of CoTaZr/Ru/CoTaZr, a nonmagnetic granular underlayer of CoCrSiO₂, a granular magnetic layer of CoCrPt—SiO₂.TiO₂ and a hydrogenated carbon protective layer sequentially with an in-line type sputtering apparatus and then film-forming a perfluoropolyether lubricating layer by dipping method on the glass substrate. Here, a Ru underlayer may be used in substitution for the nonmagnetic granular underlayer of CoCrSiO₂. In addition, a seed layer of NiW may be added between the soft magnetic layer and the underlayer. A magnetic layer of CoCrPtB may be also added between the granular magnetic layer and the protective layer.

Next, examples performed for making clear the effects of the present invention are described.

### Examples and Comparative Examples

### (1) Material Processing Step

Molten aluminosilicate glass was formed into a disk shape by direct pressing using upper, lower, and drum molds, thereby obtaining an amorphous sheet glass. A glass which contains, as main components, SiO₂: 58 wt % to 75 wt %, Al₂O₃: 5 wt % to 23 wt %, Li₂O: 0 wt % to 10 wt % and Na₂O: 4 wt % to 13 wt % was used as the aluminosilicate glass. Here, Li₂O may be not less than 0 wt % and not more than 7 wt %.

### (2) First Grinding (Lapping) Step

Then, both the main surfaces of the disk-shaped glass substrate were subjected to lapping. The lapping was carried out using a double-sided lapping machine employing a planetary gear mechanism with the use of alumina-based free abrasive grains. Specifically, the lapping was carried out by pressing lapping surface plates onto the both surfaces of the glass substrate from the upper and lower sides, supplying a grinding fluid containing the free abrasive grains onto the main surfaces of the sheet glass, and relatively moving them to carry out the lapping. By this lapping, the glass substrate having flat main surfaces can be obtained.

### (3) Cutting-Out Step (Coring, Chamfering)

Then, an inner opening was formed at the center part of this glass substrate with a cylindrical diamond drill, thereby obtaining an annular glass substrate (coring). And grinding was applied to the outer peripheral edge face and inner peripheral edge face using diamond grindstones, thereby carrying out predetermined chamfering processing (chamfering).

### (4) Second Lapping Step

Then, the second lapping step was applied to both the main surfaces of the obtained glass substrate in the same manner as in the first lapping step. By performing this second lapping step, fine irregularities formed on the main surfaces in the cutting-out step or edge face polishing step as a previous step can be removed in advance. Consequently, it becomes possible to complete a subsequent main surface polishing step in a short time.

### (5) Edge Face Polishing Step

Then, the outer peripheral edge face and inner peripheral edge face of the glass substrate were mirror-polished by a brush polishing method. For this purpose, as polishing abrasive grains, a slurry (free abrasive grains) containing cerium oxide abrasive grains were used. And the glass substrate for which the edge face polishing step was finished was water washed. By this edge face polishing step, the edge faces of the glass substrate were finished to a mirror surface state which could prevent the segregation of sodium and potassium.

### (6) Main Surface Polishing Step (First Polishing Step)

The first polishing step was first carried out as a main surface polishing step. This first polishing step mainly aims to remove cracks or strains remaining on the main surfaces during the foregoing lapping step. In this first polishing step, the main surfaces were polished with a double-sided polishing machine having a planetary gear mechanism along with the use of a hard resin polisher. Cerium oxide abrasive grains were used as a polishing agent.

The glass substrate subjected to the first polishing step was washed by dipping the substrate sequentially in cleaning tanks respectively of a neutral detergent, pure water, IPA (Isopropyl alcohol).

### (7) Chemical Strength Step

Then, chemical strength treatment (ion-exchange treatment) was applied to the glass substrate subjected to the main surface polishing step. A chemical strength solution in which potassium nitrate (60%) and sodium nitrate (40%) were mixed was prepared, and the chemical strength was performed by heating the chemical strength liquid to 400° C. and preheating the glass substrate for which cleaning is finished to 300° C. and dipping the substrate in the chemical strength solution for about three hours. This dipping was performed in a state that plural glass substrates were held at the edge faces in a holder so that the whole of the surfaces of the glass substrates might be chemically strengthened.

Lithium and sodium ions in the surface layer of the glass substrates were respectively substituted with sodium and potassium ions in the chemical strength solution by performing a dipping treatment in the chemical strength solution in this way, thereby the glass substrates were strengthened.

### (8) Main Surface Polishing Step (Final Polishing Step)

Next, the second polishing step was carried out as a final surface polishing step. This second polishing step aims to perform polishing so as to reduce the predetermined film thickness corresponding to the compressive stress layer formed on the glass substrate and to finish the main surfaces to mirror-like surfaces. In this Example, the main surfaces are polished with a double-sided polishing machine having a planetary gear mechanism along with the use of a soft foaming resin polisher so as to mirror-polish the main surfaces. Colloidal silica abrasive grains (average particle size 5 nm to 80 nm) finer than the cerium oxide abrasive grains used in the first polishing step were used as a polishing agent.

### (9) Cleaning Step

The glass substrates subjected to the chemical strength treatment were dipped and quenched in a water bath of 20° C. and maintained for about ten minutes.

Subsequently, after the final polishing step was performed, the substrates were dipped in an aqueous solution in which oxides of plural metals (Fe, Ni, Cr, Cu, Zn) were dispersed or partly dissolved for 24 hours and to prepare pseudo contaminated substrates to confirm the iron oxide removing effect by an oxalic acid containing solution. These pseudo contaminated substrates were dipped in the cleaning liquids of respective conditions shown in Table 1 to perform cleaning treatment. The treatment time was three minutes and the treatment temperature was 50° C. Furthermore, the glass substrates subjected to oxalic acid+ammonium iron (II) sulfate cleaning were dipped and washed in each cleaning bath of pure water and IPA sequentially and dried afterwards. The initial count of contaminating substances before the cleaning step of the pseudo contaminated substrates was about 10,000 on average.

### (Defect Evaluation)

Defects were inspected for respective glass substrates obtained in Examples and Comparative Examples with an optical defect tester (product name OSA6100 produced by KLA-Tencor Company). As a measurement condition, the laser wavelength was 405 nm at a laser power of 25 mW with a laser spot diameter of 5 μm and an area between 15 mm to 31.5 mm from the center of the glass substrate was measured. Among the defects detected having a size equal to or less than 1.0 μm, the number (per 24 cm²) of adhering defects was shown in Table 1. Here, the number of defects was measured by counting the number of the defects which remained in the same positions after the cleaning step while assuming the defects on the surface of the glass substrate before the cleaning step as a standard. The defects in these Examples refer to metallic contaminants (more specifically fine particles) sticking to the glass substrate surface. In addition, 20 from the defect number which remained were picked up at random and the sticking residual substances were analyzed with SEM/EDX and the presence/absence of the iron-based defects was determined.

(Evaluation after Cleaning with an Acidic Cleaning Liquid)

### (Surface Measurement of Glass Substrates)

The respective glass substrates obtained in Examples and Comparative Examples were measured with an atomic force microscope Nanoscope produced by Japan Veeco Corporation at a resolution of 256×256 pixels per 2 μm×2 μm and the surface roughness (arithmetical average roughness (Ra)) was determined. The results are shown in Table 1.

TABLE 1

| | Oxalic acid | Additives capable of | Ascorbic acid | | | Surface | Presence of |
|---|---|---|---|---|---|---|---|
| | concentration | forming iron(II) ion and | concentration | | Number of | roughness | iron-based defects |
| | (wt %) | concentration thereof (wt %) | (wt %) | pH | defects | Ra(nm) | per 20 defects |
| Example 1 | 0.2 | Ammonium iron sulfate 0.02 | 0.2 | 2.2 | 235 | 0.19 | NO |
| Example 2 | 0.5 | Iron sulfate 0.015 | 0.3 | 2.2 | 190 | 0.18 | NO |
| Example 3 | 1.1 | Ammonium iron sulfate 0.1 | 0.5 | 2.2 | 165 | 0.20 | NO |
| Example 4 | 0.6 | Ammonium iron sulfate 0.25 | 0.3 | 2.2 | 150 | 0.20 | NO |
| Example 5 | 2.8 | Ammonium iron sulfate 0.02 | 0.4 | 2.2 | 155 | 0.18 | NO |
| Example 6 | 0.2 | Iron sulfate 0.05 | 0.4 | 3.9 | 235 | 0.18 | NO |
| Example 7 | 1.0 | Iron sulfate 0.05 | 0.4 | 3.9 | 225 | 0.16 | NO |
| Example 8 | 1.1 | Ammonium iron sulfate 0.1 | 0.5 | 3.9 | 220 | 0.16 | NO |
| Comparative | 0.5 | 0 | 0 | 2.2 | 460 | 0.21 | YES |
| Example 1 | | | | | | | |
| Example 9 | 0.6 | Ammonium iron sulfate 0.35 | 0.3 | 2.2 | 150 | 0.19 | NO |
| Reference | 0.1 | Iron sulfate 0.1 | 0.4 | 2.2 | 345 | 0.18 | YES |
| Example 1 | | | | | | | |
| Example 10 | 3.5 | Ammonium iron sulfate 0.02 | 0.4 | 2.2 | 155 | 0.20 | NO |
| Reference | 0.1 | Iron sulfate 0.08 | 0.4 | 3.9 | 360 | 0.17 | YES |
| Example 2 | | | | | | | |
| Comparative | 0.5 | Ammonium iron sulfate 0.06 | 0.3 | 1.7 | 95 | 0.35 | NO |
| Example 2 | | | | | | | |
| Comparative | 0.5 | Iron sulfate 0.08 | 0.3 | 4.3 | 375 | 0.17 | YES |
| Example 3 | | | | | | | |
| Example 11 | 0.5 | Ammonium iron sulfate 0.06 | 0.3 | 1.8 | 100 | 0.20 | NO |
| Example 12 | 0.11 | Iron sulfate 0.1 | 0.4 | 2.2 | 220 | 0.18 | NO |
| Example 13 | 0.11 | Iron sulfate 0.08 | 0.4 | 3.9 | 230 | 0.17 | NO |
| Example 14 | 0.5 | Iron sulfate 0.08 | 0.3 | 4.2 | 225 | 0.17 | NO |
| Example 15 | 0.25 | Ammonium iron sulfate 0.25 | 0.3 | 2.2 | 160 | 0.20 | NO |
| Example 16 | 0.6 | Ammonium iron sulfate 0.25 | — | 2.2 | 170 | 0.20 | NO |

From Table 1, the number of contaminating substances which adhered to the glass substrate was able to be reduced by using a cleaning liquid in which divalent iron ions was added to oxalic acid as a cleaning liquid of the glass substrate as compared with the case of using a cleaning liquid in which divalent iron ions was not added to oxalic acid (Comparative Example 1). In particular, the number of the iron-based defects was able to be removed effectively.

In addition, when the oxalic acid concentration was not less than 1.1 wt %, the number of defects was able to be reduced effectively, and when the oxalic acid concentration was not less than 3.0 wt %, significant change in the removal effect of the iron oxide particles was not observed (Example 10). Likewise, when the concentration of ammonium iron (II) sulfate in the cleaning liquid was not less than 0.3 wt %, significant change in the removal effect of the iron oxide particles was not observed (Example 9).

In addition, when pH of the cleaning liquid containing oxalic acid and divalent iron ions was made not less than 1.8, surface roughness of the glass substrate was able to be reduced and at the same time, when pH was made not more than 4.2, the number of contaminating substances which adhered to the glass substrate was able to be reduced effectively (Examples 11, 14). A certain effect was obtained even if ascorbic acid which functioned as a reducing agent was not added (Example 16).

From the above-mentioned results, metallic contaminants (particularly, iron-based contaminant) were able to be removed effectively without affecting the surface of the glass substrate by using the cleaning liquid in which a divalent iron ions is added to oxalic acid.

Incidentally, the oxalic acid concentration is prescribes in wt % in this Example but it may be prescribed in mol/L. For example, when the oxalic acid concentration is 0.2 wt %, it is 0.016 mol/L. This is because, assuming oxalic acid to be used as oxalic acid dihydrate (molecular weight 126.03 g/mol), this becomes 2 g/L (approximately equal to 0.2 wt %)/(126.03 g/mol)=0.016 mol/L.

Likewise, in the case of the ammonium iron (II) sulfate, it is assumed to be the use of ammonium iron (II) sulfate hexahydrate (molecular weight: 392.14 g/mol) and in the case of the iron (II) sulfate, it is assumed to be the use of iron (II) sulfate heptahydrate (molecular weight: 278.01 g/mol). For example, the case of 0.02 wt % of ammonium iron (II) sulfate becomes 0.2 g/L (approximately equal to 0.02 wt %) (392.14 g/mol)=0.0005 mol/L. The case of 0.015 wt % of iron (II) sulfate becomes 0.15 g/L (approximately equal to 0.015 wt/(278.01 g/mol)=0.0005 mol/L.

As for ascorbic acid (molecular weight: 176.12 g/mol), thioglycollic acid (molecular weight: 92.12 g/mol) and thioglycollic acid ammonium (molecular weight 109.15 g/mol) which are reducing agents, they may be prescribed in mol/L

### (DFH Touchdown Test)

Next, magnetic disks are prepared using the glass substrates for which a cleaning step was performed without newly performing pseudo-contamination in the conditions of Examples and Comparative Examples shown in Table 1 mentioned above and a touchdown test of a DFH head element part was performed using an HDF tester (Head/Disk Flyability Tester) produced by Kubota Comps Corporation. This test slowly pushes out the element part by DFH mechanism and evaluates the distance when the head element part contacts with the magnetic disk surface by detecting the contact with the magnetic disk surface by way of an AE sensor. The head used was a DFH head for 320 GB/P magnetic disks (2.5 inch size). The flying height when the element part is not pushed out is 10 nm. The other conditions were set as follows.

Magnetic disk: 2.5-inch glass substrates (20 mm in inside diameter, 65 mm in outside diameter, 0.8 mm inboard thickness) were produced and a recording layer and the like were film-formed on the glass substrates.

Evaluation radius: 22 mm
Number of revolutions of the magnetic disk: 5400 RPM

### Temperature: 25° C.

### Humidity: 60%

The film formation of the recording layer on the glass substrate was performed as follows. At first, the film formation apparatus was drawn to vacuum, and adhesion layer/soft magnetic layer/pre-underlayer/underlayer/main recording layer/auxiliary recording layer/protective layer/lubrication layer were sequentially film-formed on the substrate in an Ar atmosphere by DC magnetron sputtering method. The Ar gas-pressure at the time of the film formation was 0.6 Pa unless otherwise indicated. As the adhesion layer, Cr-50Ti was film-formed to 10 nm. As the soft magnetic layer, 92Co-3Ta-5Zr was film-formed respectively to 20 nm sandwiching a 0.7-nm Ru layer. As the pre-underlayer, Ni-5W was film-formed to 8 nm. As the underlayer, Ru was film-formed to 10 nm at 0.6 Pa and Ru was film-formed to 10 nm at 5 Pa thereon. As the main recording layer, 90(72Co-10Cr-18Pt)-5(SiO₂)-5(TiO₂) was film-formed to 15 nm at 3 Pa. As the auxiliary recording layer, 62Co-18Cr-15Pt-5B was film-formed to 6 nm. As the protective layer, C₂H₄ was film-formed to 4 nm by CVD method and the surface layer was subjected to nitriding treatment. As the lubrication layer, PFPE was formed to 1 nm by a dip coating method.

Results of the DFH touchdown test are shown in Table 2. Here in Table 2, evaluation was made as follows depending on the distance (assuming this as x) at which the head element part and the magnetic disk contacted.

◯: x≦1.0 nm
Δ: 1.0 nm<x

TABLE 2

| | Oxalic acid | Additives capable of | Ascorbic acid | | DFH |
|---|---|---|---|---|---|
| | concentration | forming iron(II) ion and | concentration | | pushing-out |
| | (wt %) | concentration thereof (wt %) | (wt %) | pH | test |
| Example 1 | 0.2 | Ammonium iron sulfate 0.02 | 0.2 | 2.2 | ◯ |
| Example 2 | 0.5 | Iron sulfate 0.015 | 0.3 | 2.2 | ◯ |
| Example 3 | 1.1 | Ammonium iron sulfate 0.1 | 0.5 | 2.2 | ◯ |
| Example 4 | 0.6 | Ammonium iron sulfate 0.25 | 0.3 | 2.2 | ◯ |
| Example 5 | 2.8 | Ammonium iron sulfate 0.02 | 0.4 | 2.2 | ◯ |
| Example 6 | 0.2 | Iron sulfate 0.05 | 0.4 | 3.9 | ◯ |
| Example 7 | 1.0 | Iron sulfate 0.05 | 0.4 | 3.9 | ◯ |
| Example 8 | 1.1 | Ammonium iron sulfate 0.1 | 0.5 | 3.9 | ◯ |
| Comparative | 0.5 | 0 | 0 | 2.2 | Δ |
| Example 1 | | | | | |
| Example 9 | 0.6 | Ammonium iron sulfate 0.35 | 0.3 | 2.2 | ◯ |
| Example 10 | 3.5 | Ammonium iron sulfate 0.02 | 0.4 | 2.2 | ◯ |
| Comparative | 0.5 | Ammonium iron sulfate 0.06 | 0.3 | 1.7 | Δ |
| Example 2 | | | | | |
| Comparative | 0.5 | Iron sulfate 0.08 | 0.3 | 4.3 | Δ |
| Example 3 | | | | | |
| Example 11 | 0.5 | Ammonium iron sulfate 0.06 | 0.3 | 1.8 | ◯ |
| Example 12 | 0.11 | Iron sulfate 0.1 | 0.4 | 2.2 | ◯ |
| Example 13 | 0.11 | Iron sulfate 0.08 | 0.4 | 3.9 | ◯ |
| Example 14 | 0.5 | Iron sulfate 0.08 | 0.3 | 4.2 | ◯ |
| Example 15 | 0.25 | Ammonium iron sulfate 0.25 | 0.3 | 2.2 | ◯ |
| Example 16 | 0.6 | Ammonium iron sulfate 0.25 | — | 2.2 | ◯ |

From Table 2, in the case wherein the glass substrates under cleaning conditions of the Examples (without pseudo-contamination) were used, the distance at which the head element part and the magnetic disk contacted was able to be reduced to as low as not more than 1.0 nm. On the other hand, in the case wherein the glass substrates under cleaning conditions of the Comparative Examples (without pseudo-contamination) were used, the distance at which the head element part and the magnetic disk contacted was more than 1.0 nm. It is thought that this is the effects of the surface roughness and the number of defects on the glass substrate. From this result, the distance at which the head element part and the magnetic disk contacted was able to be reduced by forming a magnetic disk using a glass substrate subjected to the cleaning which was performed with a cleaning liquid in which a divalent iron ions is added to oxalic acid as a cleaning liquid of the glass substrate.

The present invention is not limited to the embodiments mentioned above and can be carried out with appropriate modification. For example, materials, size, treatment procedure, inspection procedure in the embodiments mentioned above are examples and the invention can be carried out with various modifications within the scope in which the effects of the present invention are exhibited. In addition, the invention can be carried out with appropriate modifications as long as they do not deviate from the scope of objects of the present invention.

The present application is based on Japanese Patent Application No. 2010-081806 filed on Mar. 31, 2010. The contents thereof are entirely incorporated herein.

1. A manufacturing method of a glass substrate for a magnetic disk having a cleaning step of the glass substrate wherein the cleaning step comprises a treatment of contacting the glass substrate with a cleaning liquid containing oxalic acid and divalent iron ions and having a pH of not less than 2 and not more than 4.

2. The manufacturing method of a glass substrate for a magnetic disk according to claim 1, wherein the concentration of oxalic acid in the cleaning liquid is not less than 0.2 wt % and not more than 3.0 wt %.

3. The manufacturing method of a glass substrate for a magnetic disk according to claim 1, wherein the cleaning liquid is prepared by adding a material which can supply divalent iron ions.

4. The manufacturing method of a glass substrate for a magnetic disk according to claim 3, wherein the material which can supply divalent iron ions is at least one selected from a group consisting of ammonium iron (II) sulfate, iron (II) sulfate and iron (II) oxalate.

5. The manufacturing method of a glass substrate for a magnetic disk according to claim 4, wherein the concentration of ammonium iron (II) sulfate, iron (II) sulfate or iron oxalate (II) in the cleaning liquid is not less than 0.015 wt % and not more than 0.3 wt %.

6. The manufacturing method of a glass substrate for a magnetic disk according to claim 1, wherein the cleaning liquid further contains ascorbic acid or a thioglycollic acid-based compound.

7. The manufacturing method of a glass substrate for a magnetic disk according to claim 6, wherein the concentration of ascorbic acid or a thioglycollic acid-based compound in the cleaning liquid is not less than 0.2 wt % and not more than 0.5 wt %.

8. The manufacturing method of a glass substrate for a magnetic disk according to claim 1, wherein the cleaning liquid further contains an alkaline aqueous solution.

9. The manufacturing method of a glass substrate for a magnetic disk according to claim 1, wherein iron oxides on the glass substrate are removed by contacting the glass substrate with the cleaning liquid.

10. A manufacturing method of a glass substrate for a magnetic disk comprising a polishing step of polishing the main surfaces of the glass substrate with a polishing apparatus having polishing surface plates containing iron; and a cleaning step of cleaning the glass substrate after the polishing step wherein the cleaning step is carried out by performing cleaning with a cleaning liquid containing an oxalate ion and divalent iron ions under acidic condition.

11. A manufacturing method of a glass substrate for a magnetic disk comprising a cleaning step of the glass substrate wherein the cleaning step is carried out by performing cleaning with a cleaning liquid containing an oxalate ion and divalent iron ions under acidic condition so as to dissolve iron-based contaminating substances present on the glass substrate.

12. A manufacturing method of a glass substrate for a magnetic disk comprising a cleaning step of the glass substrate wherein the cleaning step is carried out by performing cleaning the glass substrate with a cleaning liquid converting iron-based contaminating substances present on the glass substrate to divalent iron ions.

13. The manufacturing method of a glass substrate for a magnetic disk according to claim 10, wherein the surface roughness of the glass substrate before the cleaning step is not more than 0.2 nm.

14. The manufacturing method of a glass substrate for a magnetic disk according to claim 10, wherein the surface roughness of the glass substrate after the cleaning step is not more than 0.2 nm.

15. The manufacturing method of a glass substrate for a magnetic disk according to claim 10, wherein the polishing step polishes the glass substrate with silica abrasive grains having an average particle size of not more than 30 nm.

16. The manufacturing method of a glass substrate for a magnetic disk according to claim 10, wherein the pH of the cleaning liquid is set to not less than 1.8 and not more than 4.2.
